(19) United States
(12) Patent Application Publication
(10) Pub. No.: US 2010/0259040 A1
(43) Pub. Date: Oct. 14, 2010

(54) COUPLING AND METHOD FOR JOINING

(76) Inventors: Trygve Kjolseth, Oslo (NO); Bjorn Melve, Trondheim (NO)

Correspondence Address: WENDEROTH, LIND & PONACK, L.L.P., 1030 15th Street, N.W.,, Suite 400 East, Washington, DC, 20005-1503, US

(21) Appl. No.: 12/602,264

(22) PCT Filed: May 28, 2008
(86) PCT No.: PCT/NO2008/000188

§ 371 Date: Jun. 28, 2010

(30) Foreign Application Priority Data
May 30, 2007 (NO) 20072738

(51) Int. Cl. F16L 47/00; B29C 65/52

(52) U.S. Cl. 285/296.1; 156/60

(57) ABSTRACT

A coupling comprising a first male part (1) and a second female part (2), where the male part is inserted into the female part and a ring shaped cavity thereby is formed between the parts. The cavity is delimited axially by means of a inner seal (4) and an outer seal (5). A bore (6) extending from the outer surface of the female part to the cavity (3) is used for injecting glue, and there is at least one bore (7) from the cavity (3) to the outer surface of the female part for venting air and draining excess glue. A seal (T) is placed in the bore (7) after the cavity is filled with glue, and some glue has drained through the bore (7), but before the glue has hardened. A method for establishing a permanent connection utilizing the coupling is described.

### AREA OF INVENTION

The current invention relates to a coupling between a first part in the form of a male part and a second part in the form of a female part, and a method whereby the coupling is joined permanent by gluing. The coupling and the method are particularly relevant to pipe systems.

### BACKGROUND OF INVENTION AND PRIOR ART

Gluing is particularly used for the joining of parts of non-welding material, such as reinforced thermo hardened polymer material, for example pipe and pipe parts of fibre reinforced polymer material, so-called FRP (fibre reinforced polymer).

Patent publication NO 311272 describes a glue joint together and a joining method. More precisely, a joint is created by gluing together two objects where at least one comprises a pipe shaped joint coupling section, which can be pulled over the second object, distinguished in that a limited cavity is created between the second object and the pipe shaped joint coupling section on the first object; and that a first bore extends from the outer surface of the pipe shaped joint coupling section to said cavity, through which first bore glue can be pressed into the cavity. The publication further describes a method for joining in accordance with the above, by joining together two objects; at least one of these is pipe shaped in the section of the joint and is arranged to be pulled onto the second object, distinguished by closing an opening created between the pipe shaped joint coupling section and the second object when the pipe shaped section is pulled onto the latter with the objective to create a limited cavity between the objects and by pressing glue through a bore formed in the pipe shaped joint coupling section with the object of filling the cavity completely with glue.

The glue joint in accordance with NO 311272 has proved to be very successful and is particularly used in pipe systems of relatively moderate dimension, such as compressed air systems, sprinkler systems, cooling systems, systems for mild chemicals, drainage, waste and treatment plants. For such pipe systems, labour contribution at installation is typically about 80% of the cost, while the cost of components is about 20%. It has been demonstrated that pipe systems with glued joints in accordance with NO 311272 may half the cost at installation because the installation is significantly simplified. The pipes that are used are typically produced from fibreglass and vinyl ester, the coupling parts are typically produced from phenol resin and fibreglass, while the glue is typically of the epoxy type, for example of the Araldite type.

However, it has been demonstrated that one embodiment of the glue joint according to NO 311272 demands particular awareness in order to secure the required quality. The mentioned form of execution or embodiment is illustrated by FIG. 2 (corresponds to FIG. 2 in NO 311272) and comprises two air vents 14, where one vent is near the inner side of the cavity and one vent is near the outer side of the cavity. The inner side here means closest to the joint, i.e. the side of the cavity that is nearest to the end of the male part 9. At installation the glue pistol is brought in towards the feed-through 13, glue is injected into the cavity 10 and completely fills this, whereas glue by further injection will leak through the air vents 14. It has been demonstrated that during installation, particular attention must be given so that the glue leaks out in significant degree from both air vents and in particular the inner air vent. If glue is not sufficiently filled also into the inner air vent, there will be a possible path for fluid leakage in a pipe system with such glued couplings. The reason for this is that fluid under pressure in pipe system will follow the contact surface between the pipe parts 9 and 8; and if the fluid has sufficient pressure, it may penetrate past the seal 11 and reach the inner air vent 14 and possibly further. In FIG. 2, the leakage path is illustrated with arrow L. Glue, which is injected into the cavity 10 would flow around the ring shaped cavity; and two glue fronts will meet at diametrically opposite sides of the feed-through 13. The glue will flow easiest where the resistance against the flow is lowest, so that the glue fronts will first meet by the ring shaped central line, or where the ring shaped cavity has greatest height and thereby renders lowest flow resistance for the glue. Along the edges of the cavity, diametrically opposite from the feed-through 13, pockets can be formed, which is not filled with glue. When the pressure from the glue pistol is released, a redistribution of the glue may take place around the said pockets, which thereby can grow in size, so that possible leakage paths may be formed. The air vents 14 in FIG. 2 may thereby merge with the said pockets and form a leakage path, particularly for the air vent and the pockets nearest the pressurised side of the coupling.

The is a need for a coupling, which is completely safe in relation to the above mentioned problem and the objective of the present invention is to provide such coupling.

### SUMMARY OF THE INVENTION

A surprising and efficient solution to the above-mentioned problem has now been found in form of a new execution or embodiment of a coupling of the mentioned type and a method for joining the coupling.

With the present invention a coupling is provided, comprising a first part in the form of a male part and a second part in the form of a female part, the male part can be brought into the female part and thereby form a ring shaped cavity between facing surfaces of the male and female parts, which ring shaped cavity in the axial direction of the parts is limited by an inner restriction at an inner side and an outer restriction at an outer side, an opening is arranged extending from the outer surface of the female part to the cavity, for injection of glue into the cavity, and at least one feedthrough is arranged extending from the cavity to the outer surface of the female part, for venting and leaking out of glue when filling the cavity with glue, distinguished in that a seal is arranged sealingly in the feedthrough after the cavity has been filled with glue and glue has leaked out of the feedthrough, but before the glue has hardened.

The seal is advantageously a plug. The seal is advantageously adhesively bonded to the glue. In an advantageous execution, the seal is threaded and fits into complimentary threads in the feedthrough, which by tested has demonstrated improved sealing effect. The opening and the feedthrough are advantageously arranged diametrically opposite around the circumference, for best possible filling of the cavity with glue. In an execution, two or more feedthroughs are arranged, each with a sealing seal, also arranged in the opening after the gluing is completed. The seal can in principal have any design, which is sealing, all from a masking tape or liner for plugs, bolts, screws, pins, nails and more. The seal is advantageously of a material that binds well to the glue, for example screws or plugs from ABS polymer or stainless steel.

A method for permanent joining of a coupling in accordance with the invention is also provided, comprising injecting glue through the opening by means of a glue pistol or similar, until the cavity has been filled with glue and glue leaks out of the at least one feedthrough, distinguished in that a seal is arranged sealingly in the feedthrough before the glue has hardened. A seal is advantageously arranged sealingly in possible further feed-through and in the opening before the glue has hardened. Most preferably, a seal is arranged first in the feed-through nearest the outer side of the coupling, thereafter in possible further feed-through in succession across from the outer side of the coupling; and finally in the opening before the glue has hardened as this provides maximal sealing effect.

The inner side refers to the side along the longitudinal axis of the male part, furthest in the opening of the female part. Restrictions refer to a packer or seal, or that the cavity ends blindly against a wall. Male part and female part refer to two parts designed so that the male part may be brought into a complementary shaped opening in the female part with adjusted difference in dimension, so that the introduction is easily implemented. The difference in dimension between the outer diameter or width of the male part and the opening of the female part is typically 0.15 mm or larger; and restrictions in the form of packers may be adapted to make possible a relatively large difference in dimension. The male part and the female part, which are joined together, has preferably a circular cross section, but not necessarily so since the cross section may have nearly any form.

In an advantageous execution form the ring shaped cavity is asymmetrical in relation to the cross section, so that it has greater height against the inner side than the outer side. Height refers here to the distance radially from the longitudinal axis of the male part, so that a greater height provides a higher cavity and a larger cross section area for flow of glue into the cavity.

The cavity can be formed as a direct consequence of the difference in dimension between the male part and the female part, but is most advantageously designed in the form of grooves in the male part, female part or both. Most advantageously, grooves for the cavity is arranged in the female part because the female part will normally be a coupling part, which thereby would suit for joining with a cut off pipe end of corresponding dimension.

The opening for injection of glue and feedthroughs for ventilation and leakage of glue are preferably arranged diametrically opposite around the circumference, in order to secure that glue which fill the cavity arrive at the feedthrough for ventilation and leakage after the cavity has been completely filled by glue.

The restrictions are advantageous in form of packers, preferably O-rings, but can also be in form of reinforced spring packer and packers with another cross section than circular cross section.

The male part is advantageously the end of a FRP pipe and the female part is advantageously a FRP pipe coupling part.

### FIGURES

The current invention and the problem, which is the basis for it, are illustrated by two figures; of which:

FIG. 1 illustrates a coupling in accordance with the invention, and

FIG. 2 equates FIG. 2 in the patent publication NO 311272 and illustrates prior art and the underlying problem of the invention.

### DETAILED DESCRIPTION

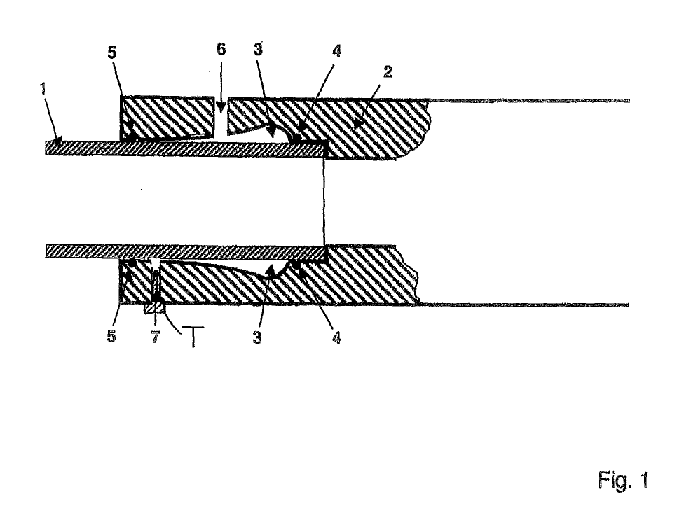

Reference is first made to FIG. 1, which illustrates a coupling in accordance with the invention. The coupling comprises a first part 1 in the form of a male part and a second part 2, in the form of a female part, in that the male part can be brought into the female part and thereby form a ring shaped cavity 3 in the contact surface between the male and the female part; which ring shaped cavity in the parts' axial direction is limited by an inner restriction 4 at an inner side and an outer restriction 5 at an outer side and an opening 6 is arranged from the outer surface of the female part to the cavity 3, for injection of glue into the cavity and at least one feedthrough 7 is arranged from the cavity to the outer surface of the female part, for ventilation and leakage of glue when filling the cavity with glue. It is further illustrated that a seal T is arranged sealingly in the feed-through 7, but before the glue has hardened, so that the seal is adhesively bonded to the glue.

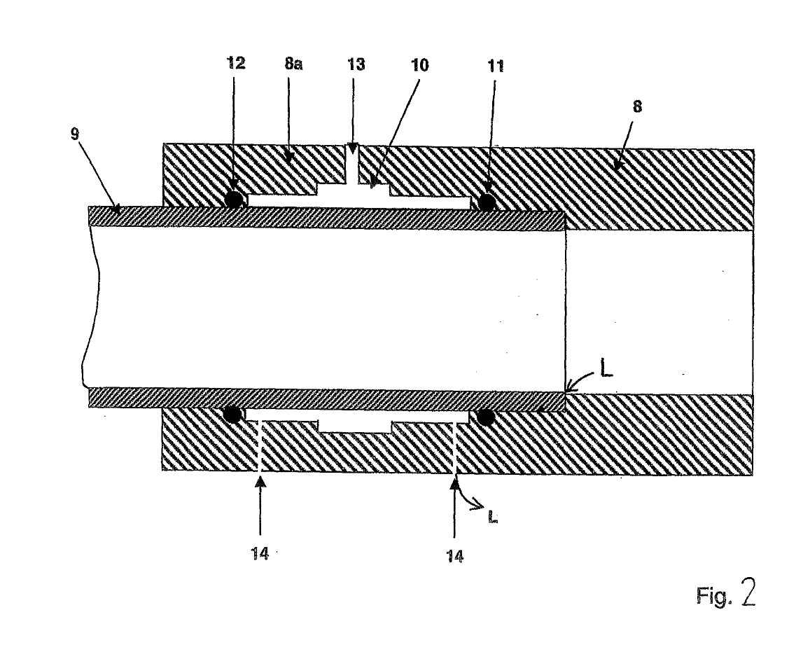

FIG. 2, as mentioned above, corresponds to FIG. 2 in patent publication NO 311272, with the exception of the leakage path L, which is added; and illustrates prior art and the underlying problem of the invention.

The invention is usable for the joining of part of all types of materials that may be glued together with suitable glue. Which parts of pipe and coupling parts that constitute the male and female parts, are interchangeable.

1-9. (canceled)

10. A coupling comprising:
a first part in the form of a male part and a second part in the form of a female part, the male part can be brought into the female part and thereby form a ring shaped cavity between facing surfaces of the male and female parts, which ring shaped cavity in the axial direction of the parts is limited by an inner restriction at an inner side and an outer restriction (5) at an outer side, an opening is arranged extending from the outer surface of the female part to the cavity, for injection of glue into the cavity, and at least one feedthrough is arranged extending from the cavity to the outer surface of the female part, for venting and leaking out of glue when filling the cavity with glue, wherein a seal (T) is arranged sealingly in the feedthrough after the cavity has been filled with glue and glue has leaked out of the feedthrough, but before the glue has hardened.

11. The coupling in accordance with claim 10, wherein the seal (T) is a plug.

12. The coupling in accordance with claim 10, wherein the seal (T) is adhesively fastened to the glue.

13. The coupling in accordance with claim 10, wherein the seal (T) is threaded and fits into complementary threads in the feedthrough.

14. The coupling in accordance with claim 10, wherein the opening (6) and the feedthroughs are arranged diametrically opposite around the circumference.

15. The coupling in accordance with claim 10, wherein two or several feedthroughs are arranged, each with a sealing seal (T) arranged, and with a sealing seal also arranged in the opening after gluing is completed, but before the glue has hardened.

16. Method for permanent joining of a coupling in accordance claim 10, comprising injecting glue through the opening by means of a glue pistol or similar, until the cavity has been filled with glue and glue leaks out of the at least one feedthrough, wherein a seal (T) is arranged sealingly in the feedthrough before the glue has hardened.

17. The method in accordance with clam 16, wherein a seal (T) is arranged sealingly in possible further feedthroughs and in the opening before the glue has hardened.

18. The method in accordance with clam 17, wherein a seal (T) is arranged first in the feedthrough, closest to the outer side of the coupling, then in possible further feedthroughs in order from the outer side of the coupling and finally in the opening, before the glue has hardened.

19. A method for permanent joining of a coupling in accordance claim 11, comprising injecting glue through the opening by means of a glue pistol or similar, until the cavity has been filled with glue and glue leaks out of the at least one feedthrough, wherein a seal (T) is arranged sealingly in the feedthrough before the glue has hardened.

20. A method for permanent joining of a coupling in accordance claim 12, comprising injecting glue through the opening by means of a glue pistol or similar, until the cavity has been filled with glue and glue leaks out of the at least one feedthrough, wherein a seal (T) is arranged sealingly in the feedthrough before the glue has hardened.

21. A method for permanent joining of a coupling in accordance claim 13, comprising injecting glue through the opening by means of a glue pistol or similar, until the cavity has been filled with glue and glue leaks out of the at least one feedthrough, wherein a seal (T) is arranged sealingly in the feedthrough before the glue has hardened.

22. A method for permanent joining of a coupling in accordance claim 14, comprising injecting glue through the opening by means of a glue pistol or similar, until the cavity has been filled with glue and glue leaks out of the at least one feedthrough, wherein a seal (T) is arranged sealingly in the feedthrough before the glue has hardened.

23. A method for permanent joining of a coupling in accordance claim 15, comprising injecting glue through the opening by means of a glue pistol or similar, until the cavity has been filled with glue and glue leaks out of the at least one feedthrough, wherein a seal (T) is arranged sealingly in the feedthrough before the glue has hardened.
